(19) United States
(12) Patent Application Publication
(10) Pub. No.: US 2006/0250736 A1
(43) Pub. Date: Nov. 9, 2006

(54) Transient blocking apparatus with electrostatic discharge protection

(76) Inventor: Richard A. Harris, Palo Alto, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/429,661

(22) Filed: May 5, 2006

Related U.S. Application Data
(60) Provisional application No. 60/678,632, filed on May 6, 2005.

(51) Int. Cl. H02H 9/00

(52) U.S. Cl. 361/56

(57) ABSTRACT

Transient blocking with electrostatic discharge (ESD) protection to be employed with a transient blocking apparatus that has a transient blocking core with an input, an output and at least one depletion mode n-channel device interconnected with at least one depletion mode p-channel device such that a transient alters a bias voltage Vₚ of the p-channel device and a bias voltage Vₙ of the n-channel device so that these devices mutually switch off to block the transient. The apparatus uses high-voltage depletion mode devices, e.g., MOSFETs, connected before the input and/or past the output of the transient blocking core in uni-directional and bi-directional embodiments, respectively. The ESD protection unit can be of the fold-back type and is connected between the input and output of the core to protect the transient blocking apparatus by causing the core to turn the high-voltage devices back on and shunting the core when dangerously high over-current conditions are produced by ESD events.

### RELATED APPLICATIONS

The present application claims priority from provisional U.S. application 60/678,632 filed on 6 May 2005 and U.S. application Ser. No. 11/130,829 filed on May 17, 2005, both of which are herein incorporated in their entirety.

### FIELD OF THE INVENTION

This invention relates generally to a Transient Blocking Unit (TBU) provided with Electrostatic Discharge (ESD) protection and in particular with ESD mechanisms that protect a transient blocking core of the TBU.

### BACKGROUND ART

Many circuits, networks, electrical devices and data handling systems are operated in configurations and environments where external factors can impair their performance, cause failure or even result in permanent damage. Among the most common of these factors are over-voltage, over-current and over-temperature. Protection against these factors is important and has been addressed in the prior art in a number of ways, depending on the specific electronics and their application.

Protection circuits are specialized depending on conditions and application. For example, in the case of protecting batteries or rechargeable elements from overcharging and over-discharging one can refer to circuit solutions described in U.S. Pat. Nos. 5,789,900; 6,313,610; 6,331,763; 6,518,731; 6,914,416; 6,948,078; 6,958,591 and U.S. Published Application 2001/0021092. Still other protection circuits, e.g., ones associated with power converters for IC circuits and devices that need to control device parameters and electric parameters simultaneously also use these elements. Examples can be found in U.S. Pat. Nos. 5,929,665; 6,768,623; 6,855,988; 6,861,828.

When providing protection for very sensitive circuits, such as those encountered in telecommunications, the performance parameters of the fuses and protection circuits are frequently insufficient. A prior art solution, commonly referred to as a transient blocking unit (TBU), satisfies a number of the constraints and is taught in international publications PCT/AU94/00358; PCT/AU04/00117; PCT/AU03/00175; PCT/AU03/00848 as well as U.S. Pat. Nos. 4,533,970; 5,742,463 and related literature cited in these references.

There are specific instances where a TBU of the type mentioned above requires electrostatic discharge (ESD) protection. Conventional ESD protection uses shunt semiconductor devices such as avalanche diodes and SCR structures to shunt the power generated by the ESD event to equipment ground. To apply this technique in protecting the TBU requires that a ground or earth pin be made available within the TBU. However, the TBU is a series device that has no ground reference. Therefore, the ESD protection mechanism or component must be applied across the TBU, i.e., between TBU input pin and the TBU output pin.

TBU components have high blocking voltages and thus, to work effectively, the ESD protection of the TBU needs to have a rated voltage above the TBU rated blocking voltage but below the TBU maximum voltage that causes irreparable harm to the TBU. This requirement places a large number of constraints on the rating of the TBU. ESD shunt components can be manufactured efficiently with a tolerance of 10% or greater. Therefore, the maximum protection rating that can be applied to the TBU is 100%-10%=90% of the maximum rating of the TBU. This is a significant reduction in the overall blocking rating of the resultant TBU.

In addition, the ESD protection must be made with a high protection voltage. High protection voltages increase exponentially the die size and cost of the ESD device due to a non-linear increase in the power-handling requirement of the die. Clearly, it would be an advance in the art to overcome these limitations affecting ESD protection for the TBU.

### OBJECTS AND ADVANTAGES

In view of the above prior art limitations, it is an object of the invention to provide ESD protection for the TBU that does not negatively affect thee overall blocking rating of the TBU.

It is another object of the invention to provide ESD protection that can be efficiently integrated with the TBU and does not exponentially increase the die size.

These and other objects and advantages of the invention will become apparent from the ensuing description.

### SUMMARY OF THE INVENTION

The objects and advantages of the invention are addressed by a transient blocking apparatus with electrostatic discharge (ESD) protection. The apparatus has a transient blocking core with an input, an output and at least one depletion mode n-channel device interconnected with at least one depletion mode p-channel device such that a transient alters a bias voltage Vₚ of the p-channel device and a bias voltage Vₙ of the n-channel device so that these devices mutually switch off to block the transient. Further, the apparatus has a high-voltage depletion mode device connected before the input or past the output of the transient blocking core. An ESD protection unit is connected between the input and output to protect the transient blocking apparatus.

The apparatus can be uni-directional or bi-directional. In the uni-directional embodiment only one high-voltage depletion mode device is required and the transient blocking core is uni-directional. In a bi-directional embodiment of the apparatus the transient blocking core is bi-directional and the apparatus has an additional high-voltage depletion mode device. Here the high-voltage depletion mode device is connected before the input and the additional high-voltage depletion mode device is connected after the output of the transient blocking core.

It is preferred that the high-voltage depletion mode devices are metal-oxide-semiconductor field effect transistors (MOSFETs). Furthermore, at least one and preferably both of the high-voltage MOSFETs are configured to switch off when the depletion mode devices in the transient blocking core mutually switch off.

Above a certain voltage the ESD protection unit is configured to reduce the voltage across the transient blocking core such that the core, and more specifically the depletion mode devices of the core switch back on and the core becomes conductive. When this happens, the core will bias the high-voltage MOSFETs to switch on as well. Typically, the voltage at which this occurs is the rated voltage of the ESD protection unit dictated by its components. Among other options, the ESD protection unit may comprise a fold-back type semiconductor that has a diac structure to fulfill this functionality. Furthermore, when the ESD protection unit is used to operate in the fold-back mode to create a low impedance shunt it should have a rated voltage lower than the rated voltage of the transient blocking core.

There are many ways in which an apparatus according to the invention can be implemented. For example, the transient blocking core can be uni-directional to block only forward transients, or bi-directional to block both forward and reverse transients (transients of both polarities). In the preferred embodiment, the transient blocking core, the high-voltage depletion mode device or devices and the ESD protection unit are all integrated. In other words, they all reside on the same die.

According to the method of invention, ESD protection is achieved by providing the transient blocking core that has an input, an output and at least one depletion mode n-channel device interconnected with at least one depletion mode p-channel device such that the transient alters the bias voltage Vₚ of the p-channel device and the bias voltage Vₙ of the n-channel device, whereby said devices mutually switch off to block the transient. A high-voltage depletion mode device is connected before the input or past the output of the transient blocking core. The ESD protection unit is connected between the input and the output to protect the transient blocking apparatus. The high-voltage device, e.g., MOSFET, is switched off as the devices in the core mutually switch off. In the bi-directional case two high-voltage devices, e.g., MOSFETs are employed before the input and after the output of the transient blocking core and they are preferably both switched off as the devices in the core mutually switch off.

In the preferred embodiment a certain voltage is selected above which the ESD protection unit reduces the voltage across the transient blocking core such that the core switches back on. This biases the high-voltage device to switch on as well and thus render the entire transient blocking apparatus conductive. In the case of a typical ESD protection unit, the certain voltage is the rated voltage of the ESD protection unit or its components. For proper shunting operation above the rated voltage of the ESD protection unit is selected to be lower than the rated voltage of the transient blocking core.

A detailed description of the preferred embodiments of the invention is presented below in reference to the appended drawing figures.

### BRIEF DESCRIPTION OF THE DRAWING FIGURES

FIG. 1 is a diagram illustrating the basic principle of operation of a prior art uni-directional transient blocking unit (TBU).

FIG. 2 is a diagram illustrating the basic principle of operation of a prior art bi-directional TBU.

FIG. 3 is a diagram of a uni-directional transient blocking apparatus with an ESD protection unit in accordance with the invention.

FIG. 4 is a diagram of a bi-directional transient blocking apparatus with an ESD protection unit according to the invention.

### DETAILED DESCRIPTION

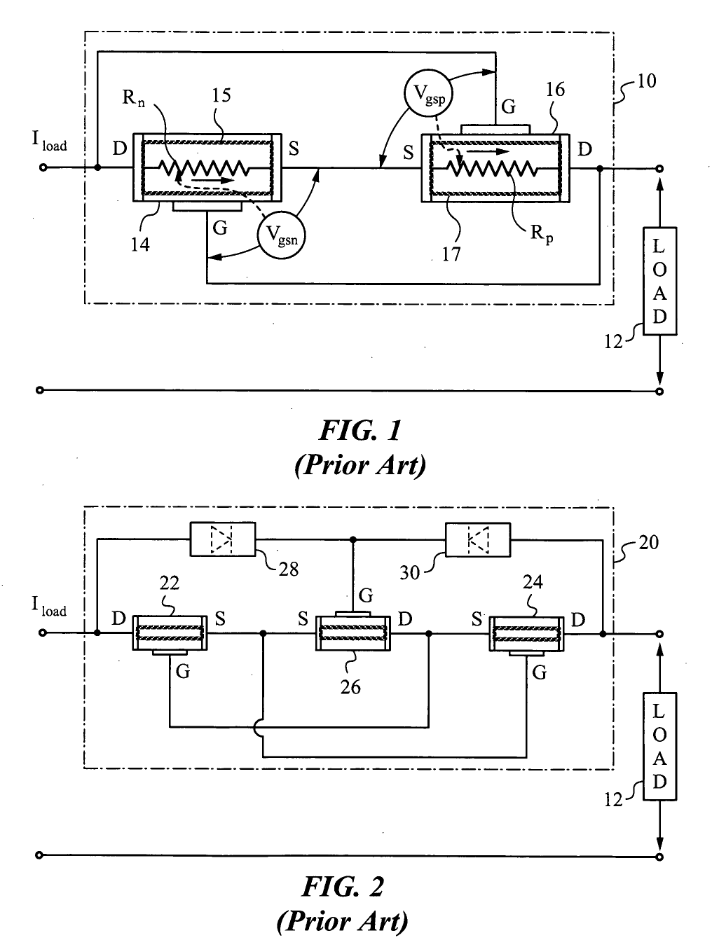

The present invention and its principles will be best understood by first reviewing prior art uni-directional and bi-directional transient blocking units (TBUs) designed for over-voltage and over-current protection. The diagram in FIG. 1 shows a prior art TBU 10 for protecting a load 12 from voltage and/or current transients of one polarity, i.e., positive voltage spikes or surges. For this reason, TBU 10 is called uni-directional. TBU 10 uses a depletion mode n-channel device 14 and a depletion mode p-channel device 16, both of which can be implemented by field effect transistors (FETs). Devices 14, 16 are interconnected to take advantage of their n-channel and p-channel biasing and resistance properties to cause mutual switch off to block the transient.

More specifically, devices 14, 16 have corresponding n- and p-channels 15, 17 as well as gate G, source S and drain D terminals. Resistances Rₙ, Rₚ of devices 14, 16 are low when voltage differences or bias voltages V_{gsn} and V_{gsp} between their gate G and source S terminals are zero. Normally, TBU 10 is unblocked and devices 14, 16 act as small resistors that allow a load current I_{load} to pass to load 12. Application of negative bias V_{gsn} to n-channel device 14 and positive bias V_{gsp} to p-channel device 16 increases resistances Rₙ, Rₚ, as indicated by the arrows and turns devices 14, 16 off. The interconnection of devices 14, 16 source-to-source and gate-to-drain reinforces the biasing off process in response to a transient. Specifically, as load current I_{load} increases device 16 develops a larger voltage drop across it, thus increasing negative bias V_{gsn} applied to device 14 and consequently increasing resistance Rₙ. Higher resistance Rₙ increases positive bias V_{gsp} on device 16 thereby increasing Rₚ. Thus, the transient alters bias voltages V_{gsn} and V_{gsp} in concert such that devices 14, 16 mutually increase their resistances Rₙ, Rₚ and switch off and thus TBU 10 blocks the transient.

The above principle of interconnection of n- and p-channel devices to achieve mutual switch off (sometimes also referred to as mutual pinch-off) is extended to bi-directional TBUs by using two uni-directional TBUs with one configured in reverse to block negative spikes. A simpler, bi-directional TBU 20 that protects load 12 from negative and positive spikes, is shown in FIG. 2. TBU 20 has two n-channel devices 22, 24 and one p-channel device 26. Devices 22, 24, 26 are interconnected between their gate G, source S and drain D terminals as shown. Two current limiters 28, 30 are used to ensure appropriate routing of current between devices 22, 24, 26. Current limiters 28, 30 can be diodes, resistors, transistors, current sources or combinations thereof. TBU 20 causes mutual switch off of devices 22, 24, 26 in response to a negative or positive spike by employing the principles of controlling resistances by biasing in response to transients as explained above.

In fact, the prior art teaches a number of variants of TBUs based on the above principles. These include, among other, TBUs that use p-channel devices at inputs, a larger number of n-channel or p-channel devices as well as TBUs that employ high-voltage depletion devices. More detailed information about prior art TBUs and associated applications and methods can be found in published literature including, in particular, PCT/AU94/00358, PCT/AU04/00117; PCT/AU03/00175; PCT/AU03/00848 and U.S. Pat. No. 5,742,463 that are herein incorporated by reference. Additional information about the use of high-voltage depletion devices in TBUs is found in U.S. patent application Ser. No. 11/130,829.

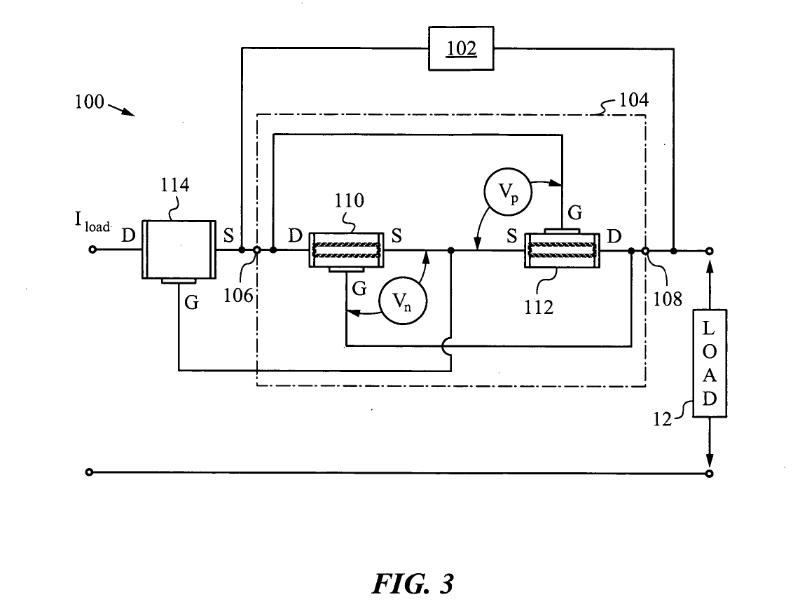

FIG. 3 illustrates a uni-directional transient blocking apparatus 100 with an electrostatic discharge (ESD) protection unit 102 in accordance with the invention. ESD protection unit 102 is of the fold-back type. Apparatus has a uni-directional transient blocking core 104 with an input 106 and an output 108. Core 104 is analogous in construction to a prior art uni-directional TBU as described above in reference to FIG. 1. Accordingly, core 104 has a depletion mode n-channel device 110 interconnected with a depletion mode p-channel device 112 such that a forward transient alters a bias voltage Vₚ of p-channel device 112 and a bias voltage Vₙ of n-channel device 110 so that these devices mutually switch off to block the forward transient. Preferably, p-channel device 110 is a field effect transistor (FET) such as a PJFET and n-channel device 112 is a metal-oxide-semiconductor (MOS) such as an n-channel MOSFET.

Further, apparatus 100 has a high-voltage depletion mode device 114 connected before input 106 of core 104. ESD protection unit 102 is connected between input 106 and output 108 to protect apparatus 100. It is preferred that high-voltage depletion mode device 114 be a normally on depletion mode MOSFET. Furthermore, high-voltage device 114 is configured to also switch off when the depletion mode devices 110, 112 in core 104 mutually switch off. This is accomplished by interconnecting gate G terminal of high-voltage device 114 between source S terminals of devices 110, 112.

During normal operation, when no forward transient or ESD current are present, apparatus 100 is in the conducting state and thus load current I_{load} is applied to load 12. Devices 110, 112 and high-voltage device 114 are all in the on state at this time.

We note that high-voltage device 114, especially when it is embodied by a MOSFET, can handle very high ESD currents (drain D to source S). In the off state, however, high-voltage device 114 is quite sensitive to damage by ESD voltages.

Now, during a forward transient core 104 senses it and reacts by blocking it in accordance with the above-described principles. Specifically, p-channel device 112 and n-channel device 110 mutually switch off in response to the forward transient. Because of its interconnection with n-channel and p-channel devices 110, 112, high-voltage device 114 is also biased to switch off as devices 110, 112 mutually switch off. Therefore, apparatus 100 is in the non-conducting or off state and thus blocks the forward transient as intended. In fact, the presence of high-voltage device 114 enhances the blocking capability of apparatus 100 to between 500 and 2,000 Volts—considerably above what core 104 would be able to block by itself.

However, if the forward transient is due to an ESD event that takes on the form of a fast rising over-voltage then high-voltage device 114 could be damaged. In particular, as the ESD voltage goes over the maximum blocking level of apparatus 100, high-voltage device 114 could begin to break down and additional voltage may develop across core 104 to damage it. An artisan skilled in the art will be able to ensure that this outcome (where the additional voltage develops across core 104) will only occur during fast rising ESD events and not during the more manageable slow rising transient events of lightning or power faults.

At this point, ESD protection unit 102 connected between input 106 and output 108 of core 104 comes into play. That is because above a certain voltage, ESD protection unit 102 is configured to reduce the voltage across core 104 such that devices 110, 112 switch back on and core 104 becomes conductive. The appropriate voltage for this to occur is below the rated voltage of core 104. In other words, the rated voltage of ESD protection unit 102 is selected to be lower than the rated voltage of core 104.

Once devices 110 and 112 become unblocked and core 104 switches back on, then core 104 will bias high-voltage device 114 to switch on as well because of the configuration of the connections between devices 110, 112 and 114. This renders entire apparatus 100 conductive once again. Of course, in the on state high-voltage device 114 can handle very large ESD currents.

Meanwhile, core 104 is does not take on the very large ESD current because ESD protection unit 102 is set to divert most of the current thus effectively shunting core 104. This happens above a certain voltage that is typically selected to be the rated voltage of the ESD protection unit 102. Of course, for proper shunting operation the rated voltage of ESD protection unit 102 is selected to be lower than the rated voltage of core 104.

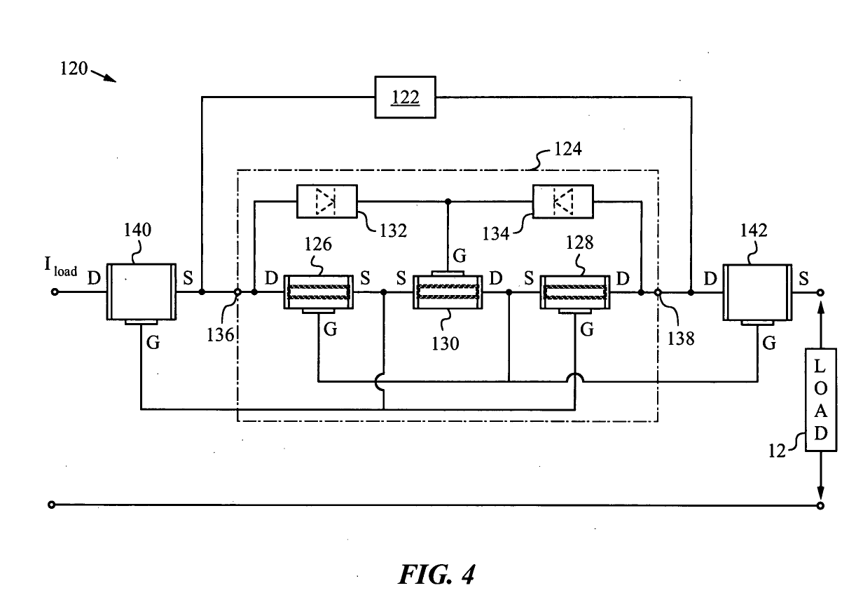

In most applications the transients or ESD events can produce large forward or reverse currents. Therefore, it is preferable that the invention be implemented in a bi-directional apparatus. An exemplary bi-directional transient blocking apparatus 120 with a fold-back type ESD protection unit 122 is shown in FIG. 4. Apparatus 120 has a transient blocking core 124 that is bi-directional. For this reason, core 124 has two depletion mode n-channel devices 126, 128 and a depletion mode p-channel device 130. Again, it is preferable that n-channel devices 126, 128 be MOSFETs and p-channel device 130 be a PJFET. Devices 126, 128 and 130 are interconnected to mutually switch off in response to transients of either polarity, i.e., forward and reverse transients. In addition, two current limiters 132, 134 are used to ensure appropriate routing of current between devices 126, 128, 130. Current limiters 132, 134 can be diodes, resistors, transistors, current sources or combinations thereof.

Core 124 has an input 136 and an output 138. A high-voltage depletion mode device 140 is connected before input 136. An additional high-voltage depletion mode device 142 is connected after output 138 of core 124. High-voltage devices 140, 142 are configured or interconnected with core 124 such that they are switched off as devices 126, 128, 130 in core 124 mutually switch off. Preferably, high-voltage devices 136, 138 are MOSFETs.

During operation, high-voltage devices 140, 142 are switched off as devices 126, 128, 130 in core 124 mutually switch off in response to forward or reverse transients. In the event of an ESD event that produces a large over-current of either polarity, ESD protection unit 122 causes devices 126, 128, 130 to switch back on. As a result of the interconnections, high-voltage devices 140, 142 are also switched on from their off state and entire apparatus 120 becomes conductive. Fold back ESD protection unit 122 shunts core 124 to thus protect it from the large over-current. Meanwhile, high-voltage devices 140, 142 are capable of handling the larger over-current since they are on.

In the preferred embodiment, transient blocking core 124, high-voltage depletion mode devices 140, 142 and ESD protection unit 122 are all integrated. In other words, they all reside on the same die. Suitable fold-back protection components for unit 122 include any typical crowbar devices such as thyristor surge suppressors or any other type of fold-back type semiconductor device. In a preferred embodiment unit 122 has a diac structure.

Many other embodiments of the apparatus and method are possible. For example, although in the preferred embodiment described above the apparatus uses on or more high-voltage devices before the input or after the output to its core, the apparatus and method of invention can be practiced when to protect a low voltage rated transient blocking core operating on its own. In such case fold-back of the device is not need and the ESD protection unit can be a clamp type component such as an avalanche diode or MOV. Of course, the ESD protection unit can also be a crowbar device (diac, sidac, fold-back diode). In those embodiments the ESD protection unit simply shunts the over-voltage and thus protects the core from damage. The voltage ratings of the core and the ESD protection unit are chosen in the manner described above to satisfy these requirements.

Still other embodiments may use additional high-voltage circuitry and/or fast response components to speed up the operation of the apparatus to rapidly rising voltage. Given all these additional possibilities, the scope of the invention should be judged by the appended claims and their legal equivalents.

We claim:

1. A transient blocking apparatus with electrostatic discharge protection, said transient blocking apparatus comprising:
a) a transient blocking core having an input, an output and at least one depletion mode n-channel device interconnected with at least one depletion mode p-channel device such that a transient alters a bias voltage Vₚ of said depletion mode p-channel device and a bias voltage Vₙ of said depletion mode n-channel device, whereby said depletion mode p-channel device and said depletion mode n-channel device mutually switch off to block said transient;
b) a high-voltage depletion mode device connected before said input or past said output;
c) an electrostatic discharge protection unit connected between said input and said output to protect said transient blocking apparatus.

2. The apparatus of claim 1, wherein said high-voltage depletion mode device comprises a normally on depletion mode MOSFET.

3. The apparatus of claim 1, wherein said high-voltage depletion mode device is interconnected to switch off when said depletion mode p-channel device and said depletion mode n-channel device mutually switch off.

4. The apparatus of claim 3, wherein above a predetermined voltage said electrostatic discharge protection unit reduces a voltage across said transient blocking core such that said transient blocking core switches on and biases said high-voltage depletion mode device to switch on.

5. The apparatus of claim 4, wherein said predetermined voltage corresponds to a rated voltage of said electrostatic discharge protection unit.

6. The apparatus of claim 1, wherein said electrostatic discharge protection unit comprises a fold-back type semiconductor.

7. The apparatus of claim 6, wherein said fold-back type semiconductor comprises a diac structure.

8. The apparatus of claim 1, wherein said electrostatic discharge protection unit has a rated voltage lower than the rated voltage of said transient blocking core.

9. The apparatus of claim 1, wherein said transient blocking core, said high-voltage depletion mode device and said electrostatic discharge protection unit are integrated.

10. The apparatus of claim 1, wherein said transient blocking core is bi-directional, said high-voltage depletion mode device is connected before said input and an additional high-voltage depletion mode device is connected after said output.

11. The apparatus of claim 1, wherein said transient blocking core is uni-directional.

12. A method for electrostatic discharge protection comprising:
a) providing a transient blocking core having an input, an output and at least one depletion mode n-channel device interconnected with at least one depletion mode p-channel device such that a transient alters a bias voltage Vₚ of said depletion mode p-channel device and a bias voltage Vₙ of said depletion mode n-channel device, whereby said depletion mode p-channel device and said depletion mode n-channel device mutually switch off to block said transient;
b) connecting a high-voltage depletion mode device before said input or after said output;
c) connecting an electrostatic discharge protection unit between said input and said output to protect said transient blocking apparatus.

13. The method of claim 12, further comprising biasing said high-voltage depletion mode device to be switched off by said transient blocking core as said depletion mode p-channel device and said depletion mode n-channel device mutually switch off.

14. The method of claim 13, further comprising selecting a predetermined voltage above which said electrostatic discharge protection unit reduces a voltage across said transient blocking core such that said transient blocking core switches on and biases said high-voltage depletion mode device to switch on.

15. The method of claim 14, wherein said predetermined voltage corresponds to a rated voltage of said electrostatic discharge protection unit.

16. The method of claim 12, further comprising selecting a rated voltage of said electrostatic discharge protection unit to be lower than the rated voltage of said transient blocking core.

17. A transient blocking apparatus with electrostatic discharge protection, said transient blocking apparatus comprising:
a) a transient blocking core having an input, an output and at least one depletion mode n-channel device interconnected with at least one depletion mode p-channel device such that a transient alters a bias voltage Vₚ of said depletion mode p-channel device and a bias voltage Vₙ of said depletion mode n-channel device, whereby said depletion mode p-channel device and said depletion mode n-channel device mutually switch off to block said transient; and
b) an electrostatic discharge protection unit connected between said input and said output to protect said transient blocking apparatus.

18. The apparatus of claim 17, wherein said electrostatic discharge protection unit comprises a clamp type component.

19. The apparatus of claim 1, wherein said electrostatic discharge protection unit has a rated voltage lower than the rated voltage of said transient blocking core.
